(19) United States
(12) Patent Application Publication
(10) Pub. No.: US 2018/0293682 A1
(43) Pub. Date: Oct. 11, 2018

(54) SYSTEM AND METHOD FOR PROVIDING SUICIDE PREVENTION AND SUPPORT

(71) Applicant: GLOBAL TEL*LINK CORPORATION, Reston, VA (US)

(72) Inventor: Stephen Lee HODGE, Aubrey, TX (US)

(21) Appl. No.: 15/479,781

(22) Filed: Apr. 5, 2017

(51) Int. Cl. G06Q 50/26; H04L 12/58; H04L 29/08; G10L 25/63; G10L 25/66; G10L 15/02; G10L 15/08; G06K 9/00; G08B 21/02

(52) U.S. Cl. CPC G06Q 50/265; H04L 51/04; H04L 67/306; G10L 25/63; G10L 25/66; G06K 2009/00738; G10L 15/08; G06K 9/00711; G08B 21/02; G10L 2015/088; G10L 15/02

(57) ABSTRACT

A system for providing suicide prevention and support for an inmate in a correctional facility is provided. The system includes an inmate communication device for personal use such as transmitting and receiving communications to and from individuals outside of the correctional facility. The system performs a prevention analysis on the communications to determine a suicidal risk of the inmate. The system calculates a prevention score indicating the likelihood of the inmate to commit suicide based on a result of the prevention analysis and also generates an alert for an administrator of the correctional facility based on the prevention score.

### BACKGROUND

### Field

The disclosure relates to systems and methods that facilitate suicide prevention and support for individuals in a controlled environment such as inmates in a correctional facility.

### Background

Traditional suicide prevention techniques used by correctional facilities include the placement of a suspected suicidal inmate under watch of a guard and the use of suicide-resistant jail cells, safety smocks, or other articles of clothing or objects that preclude or deter an inmate from attempting to commit suicide. While these techniques are a useful source of prevention, these techniques are typically only used after the correctional facility knows that a direct suicidal action has been performed by an inmate. In other words, suicide prevention techniques are typical only put into place by correctional facilities to prevent an inmate's subsequent suicidal attempt. Accordingly, there exists a need for correctional facilities to use systems and methods that are used to prevent suicides, including first attempts of suicide, by inmates.

### BRIEF DESCRIPTION OF THE DRAWINGS/FIGURES

The accompanying drawings, which are incorporated herein and form a part of the specification, illustrate embodiments of the present disclosure and, together with the description, further serve to explain the principles of the disclosure and to enable a person skilled in the pertinent art to make and use the embodiments.

FIG. 1 illustrates a block diagram of a communication system, according to exemplary embodiments of the present disclosure.

FIG. 2 illustrates a block diagram of a communication center, according to exemplary embodiments of the present disclosure.

FIG. 3 illustrates a prevention subsystem, according to exemplary embodiments of the present disclosure.

FIG. 4 illustrates a flowchart diagram of a method of the communication system, according to exemplary embodiments of the present disclosure.

FIG. 5 illustrates a flowchart diagram of a method for preventing a suicide attempt, according to exemplary embodiments of the present disclosure.

FIG. 6 illustrates a computer system, according to exemplary embodiments of the present disclosure.

The present disclosure will be described with reference to the accompanying drawings. In the drawings, like reference numbers indicate identical or functionally similar elements. Additionally, the left most digit(s) of a reference number identifies the drawing in which the reference number first appears.

### DETAILED DESCRIPTION

The following Detailed Description refers to accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the Detailed Description is not meant to limit the invention. Rather, the scope of the invention is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc. Further, any of the implementation variations may be carried out by a general purpose computer, as described below.

For purposes of this discussion, any reference to the term “module” shall be understood to include at least one of software, firmware, or hardware (such as one or more circuit, microchip, or device, or any combination thereof), and any combination thereof. In addition, it will be understood that each module may include one, or more than one, component within an actual device, and each component that forms a part of the described module may function either cooperatively or independently of any other component forming a part of the module. Conversely, multiple modules described herein may represent a single component within an actual device. Further, components within a module may be in a single device or distributed among multiple devices in a wired or wireless manner.

The following Detailed Description of the exemplary embodiments will so fully reveal the general nature of the invention that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

### Overview

One of the leading causes of deaths of inmates in a correctional facility is suicide. Typically, suicides are second to only physical health deaths, such as cancer and heart disease, and has a higher rate than homicide and drug related deaths, combined. Further, the suicide rate among inmates is typically three times the suicide rate of non-incarcerated individuals.

Traditionally, correctional facilities use suicide prevention techniques that include the use of guards to continually watch an inmate, suicide-resistant jail cells, safety smocks, or other articles of clothing or objects that are considered safe for inmates. While these techniques are useful methods of preventing suicide, they are typically only applied or given to inmates when a correctional facility knows that a particular inmate has recently attempted suicide. In other words, typical suicide prevention techniques are more of a post reactive response to an inmate's suicidal attempt and are only implemented to prevent subsequent suicide attempts. This means that these techniques do little, if anything, to prevent suicide attempts for those inmates that are contemplating suicide or have not previously performed a suicidal act. Further, conventional prevention techniques are usually removed or terminated after the inmate has shown signs of overcoming the initial suicidal tendencies and therefore do not address subsequent attempts that may occur in the distant future.

In light of the above, improved systems and methods are needed to assist correctional facilities in identifying inmates that are more likely to commit suicide and providing preventative techniques and support for the identified inmates to preclude a suicidal act from being performed.

### Communication System

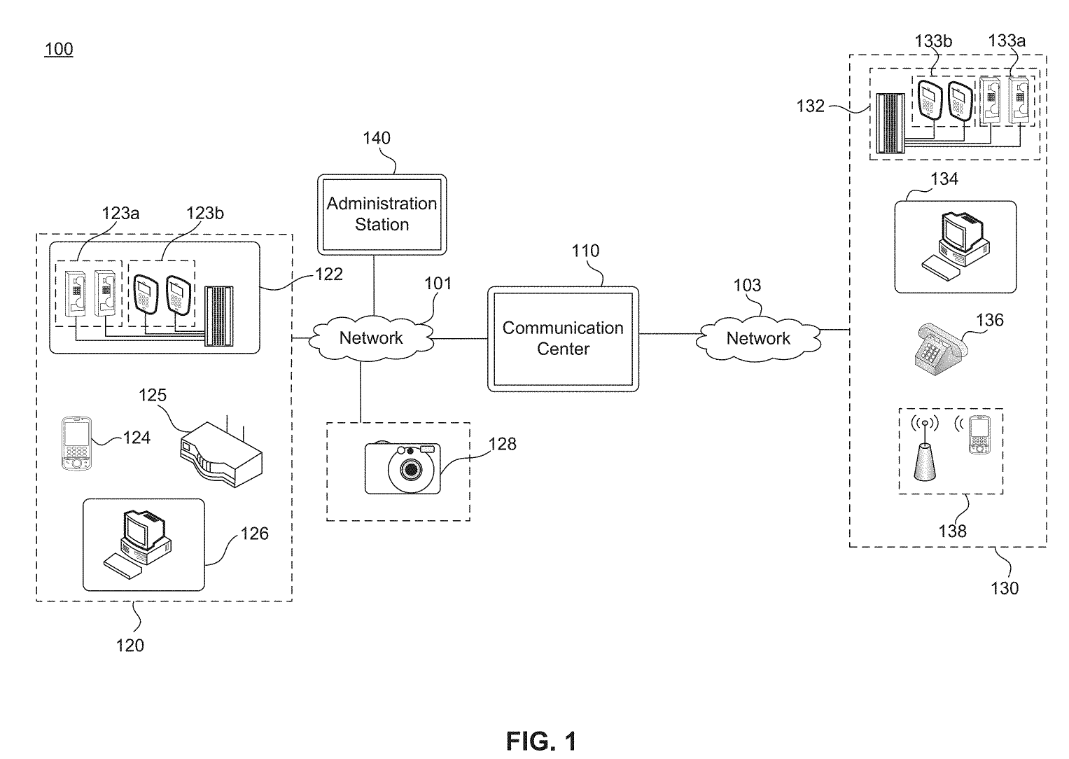

FIG. 1 illustrates a block diagram of a communication system 100, according to exemplary embodiments of the present disclosure. Communication system 100 includes a communication center 110 configured to receive and transmit communications between an inmate communication device 120 and an outsider communication device 130, communications from applications on inmate communication device 120, and/or communications from a monitoring device, such as monitoring device 128.

Inmate communication device 120 includes any or all devices such as wired communication devices 122, which include audio communication devices 123a and video communications devices 123b, wireless communication device 124, and/or a control station 126. Communication center 120 may also connect to a wireless access point 125 (e.g., a router), which may provide connectivity to wireless devices 124. Inmate communication device 120, such as video communications devices 123b, wireless communication device 125, and/or control station 126, are configured to include a camera and a screen for generating and viewing videos or images. Examples of inmate communication device 120 include a telephone, a smartphone, a personal digital assistant, a laptop, a computer, or a tablet. Communications include any and all data entered and received between inmate communication device 120 and outsider communication device.

In an embodiment, inmate communication device 120 comprises applications that an inmate interacts with. These applications are used to communicate with outsider communication device 130, such as text message applications, email applications, phone applications, or video chat applications; to communicate with computers, such as chatbots and video game servers; or to perform general information gathering, such as internet browsers or digital assistants. In this embodiment, communications also include any and all interactions that the inmate has with the applications on the inmate communication device 120. For example, communications may include any and all data entered and received during a communication between an inmate and a chatbot or a video game, or during an internet search whether by internet browser or a personal assistant.

Inmate communication device 120 connects to communication center 110 via a network 101, which includes a Local-Area Network (LAN), a Wide-Area Network (WAN), or the Internet, depending on the locations of the communication center. For example, communication center 110 may be located at a correctional facility where inmate communication device 120 is located and therefore a LAN is used. In another example, communication center 110 is located at a different location than the correctional facility and therefore network 101 is a WAN or the Internet.

In an embodiment, communication system 100 also includes a monitoring device 128 located at a correctional facility and configured to monitor movements, actions, or sounds of an inmate in a cell. Monitoring device 128 transmits the monitored actions of the inmate to communication center 110. Examples of monitoring device 128 may include an image or video camera and/or a microphone. Monitoring device 128 connects to communication center 110 via network 101. In this embodiment, communications also include any and all data transmitted to communication center 110.

Outsider communication device 130 includes any and all devices such as wired communication devices 132, which include audio communication devices 133a and video communications devices 133b, a work station 134, a basic telephone 136, and/or a wireless communication device 138. Outsider communication device 130, such as video communications devices 133b, wireless communication device 138, and/or work station 134, are configured to include a camera and a video screen for generating and viewing a video. Outsider communication device 130 connects to communication center 110 via network 103, which may include any or all of a WAN, the Internet, and/or a Public Switched Telephone Network (PSTN). The WAN may facilitate communications with other nearby prisons, such as those within the same county, state, etc. Wired audio and/or video communication devices 132 located at those other facilities may provide cross-facility visitations between inmates. In an embodiment, WebRTC may be utilized in place of a session initiation protocol (SIP) over a WAN or the Internet, each of which provides a dedicated, private link between inmate communication device 120 and outsider communication device 130. The Internet is utilized to provide access to work station 134 such as remotely distributed control stations, scheduling clients, and home visitation devices. The PSTN can be used to provide connectivity to basic telephone 136 and/or wireless communication device 138 and other communication devices (not shown) over traditional data networks.

In an embodiment, communication system 100 includes an administrator station 140 configured to receive notifications from communication center 110 based on a suicidal risk for an inmate. Administration station 140 may include one or more of an administrative work station, such as a computer or laptop, or a portable device, such as a cell phone, tablet, or pager, or any other device configured to receive a notification. The administration station 140 may be located at a correctional facility or remote to the correctional facility. The notifications are used to alert correctional facility workers, such as administrators, guards, medical assistants, or therapists, to provide support for an inmate. In an embodiment, the alert may provide general or detailed explanations as to required support that the inmate needs.

### Communication Center

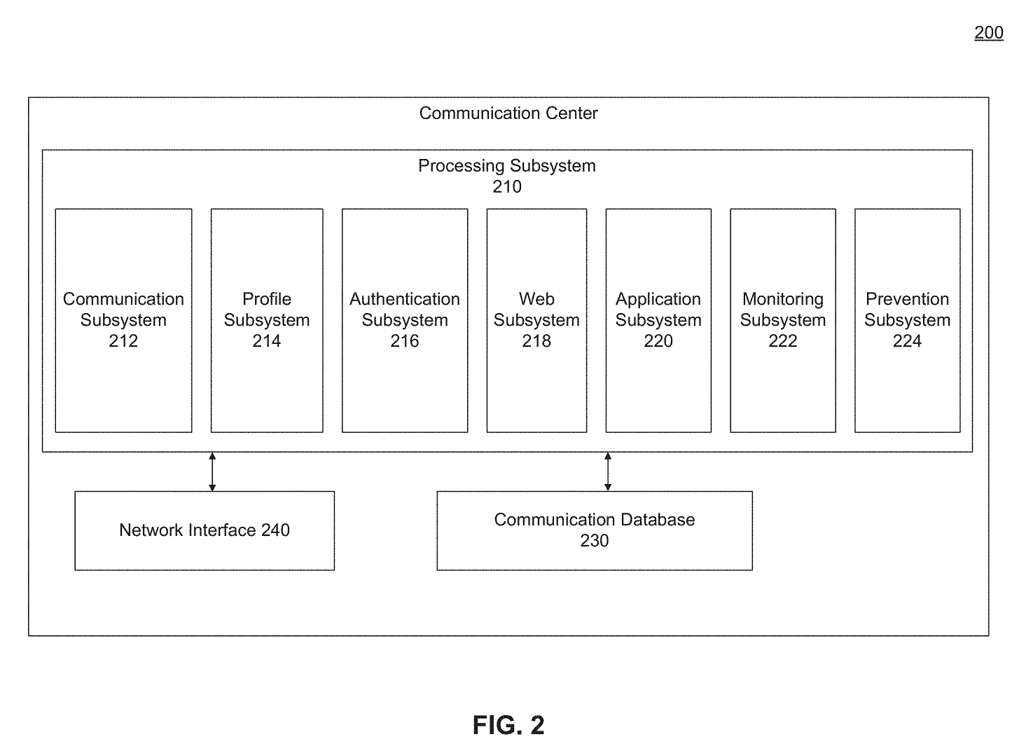

FIG. 2 illustrates a block diagram of communication center 200, according to embodiments of the present disclosure. Communication center 200 may represent an exemplary embodiment of communication center 110 of FIG. 1. Communication center 200 includes a processing subsystem 210, a database 230, and a network interface 240, as shown by FIG. 2. Processing subsystem 210 includes one or more processors, computers, or servers identified as subsystems and can be constructed as individual physical hardware devices, or as virtual devices, such as a virtual server. The number of processing subsystems can be scaled to match the number of simultaneous user connections desired to be supported by communication system 100. Processing subsystem 210 includes communication subsystem 212, profile subsystem, 214, authentication subsystem 216, web subsystem 218, application subsystem 220, monitoring subsystem 224, and prevention subsystem 224.

Communication subsystem 212 is configured to control the routing of communications to an end destination such as one of inmate communication device 120 or outsider communication device 130. In doing so, communication subsystem 212 performs switching required to electrically connect to inmate communication device 120 and outsider communication device 130. Further, communication subsystem 212 logs communication information, including time of communications and individuals involved in the communications, and stores the logs and communications as files. The files stored by communication subsystem 212 can be stored by database 230 for use by other processing subsystems.

In an embodiment, communication subsystem 212 is also configured to determine whether a communication should be monitored such that privileged communications such as attorney/client, doctor/client, or investigative communications are not monitored. Criteria for monitoring a communication may be based on jurisdictional requirements and/or identities of the individuals involved in the communication.

In an embodiment, communication subsystem 212 is further configured to receive contact information such as a phone number, email address, internet protocol address, or other identifying data of the individuals involved in the communication. The received contact information may be used by any of the processing subsystems for identifying respective data and processes related to the contact information, such as purported identities of individuals involved in the communication.

Due to a variety of different communication standards employed by different audio, video, image, and text devices that may participate in communications, in an embodiment, communication subsystem 212 is also configured to perform format conversion of communications. Conversion of incoming and outgoing communications are performed, as needed, to be compatible with inmate communication device 120, outsider communication device 130, or for monitoring purposes.

Further, because communication subsystem 212 receives and transmits communications by way of a network, in an exemplary embodiment, communication subsystem 212 is configured to decrypt received communications and encrypt transmitting communications, for security purposes.

Profile subsystem 214 is configured to obtain and store profile information on inmates. Profile information may include personal information such as previous residences or correctional facilities, authorized contacts, family members, languages, special needs, calling history, police reports, incident reports, work reviews/reports, behavior records, counseling matters, rap sheets, and Internet browsing histories, among others. The profile information may be obtained from (a) a jail management system (JMS) or an offender management system (OMS) communication systems operated by the jurisdiction of the correctional facility, (b) public database containing information on the individuals, (c) a questionnaire(s) provided by a web page, a personal approved number (PAN) list, or booking information, or (d) updated information from the prevention subsystem 224.

Authentication subsystem 216 collects and stores identity data of inmates and outsiders authorized to access the communication system 100. Identity data includes at least one of a username and password data, challenge questions, challenge answers, biometric data, device data such as make and model of a communication device, and/or location data. Biometric data includes one or more of a finger print, a hand print, a voice sample, an iris or retinal sample, an image of the user (2D or 3D), a hand geometry, a signature identification, an infrared camera identification, or any other biometric as deemed appropriate. Authentication subsystem 216 is further configured to facilitate a secure communication between individuals receiving/transmitting a communication by performing identity verifications to authenticate identities of purported individuals. The identity verification includes logon verifications, such as username and password verifications, biometric verification, response to challenge questions, device verification, and/or location verification.

Authentication subsystem 216 performs an identity verification by receiving identity information such as one or more of a username and password, a response to a challenge question(s), a keypad or touch pad entry, dual tone multi frequency (DTMF) response, a voice sample, a fingerprint sample, a retinal sample, a facial image (2D or 3D), device information such as a make and model of the communication device, and/or a location of the communication device, from a communication device (either 120 or 130) used by a purported party and comparing the identity information of the purported party with stored identity data.

Web subsystem 218 runs web server software such as Apache and/or Microsoft Internet Information Server and/or an interactive voice response (IVR) server software. The primary function of web subsystem 218 is to operate as a frontend and/or backend server in receiving and transmitting information to a party communication center 200. In an embodiment, web subsystem 218 can also serve as a maintenance point into communication center 200, by which servicing, configuring, and updating can be performed. In an embodiment, the web subsystem 218 provides managing services for generating communications, receiving instructions from a party to send or receive communications, and coordinating and scheduling the transmission of communications. For example, web subsystem 218 can facilitate a party in generating a non-real time communication when the party uses a front-end application having a user interface.

Application subsystem 220 functions as the primary logic processing center in communication center 200. Application subsystem 220 manages and facilitates overall communication between subsystems of communication center 200 and devices external to communication center 210, such as inmate communication device 120 and outsider communication device 130.

Monitoring subsystem 222 is configured to perform monitoring of communications. Monitoring subsystem 222 generates monitored data which may be used by other processing subsystems. The monitored data includes key word search results and analysis from communications that indicate rules or regulations that are not being followed by the inmate/outsider. For example, the monitored data may include notes, timestamps, bookmarks or other indications that a communication includes a discussion by the inmate or outsider regarding a crime committed or soon to be committed or an attempt by the insider or outsider to contact an unauthorized third party. The monitored data may be generated by automated processes or manual processes. For a manual monitoring process, monitoring subsystem 222 is also configured to distribute communications to monitoring stations (not shown), including stations located at or remote to the correctional facility and/or third-party stations, for review of the communications by reviewers. Monitoring subsystem 222 may be further configured to receive from the monitoring stations notifications including instructions, notes, timestamps, bookmarks, etc. created during the monitoring of the communications. All notifications may be stored as monitored data on database 230.

Prevention subsystem 224 is configured to access database 230 to retrieve at least one of the inmate data, the profile data, the content of communications, and the monitored data. The monitoring subsystem 114 analyzes retrieved data to make a determination on suicidal risks of an inmate. The determination by the prevention subsystem 224 may be an initial risk assessment based on only the inmate data and/or profile data or the risk assessment may include updates to an previous assessment based on communications involving the inmate. In an embodiment, monitoring subsystem 222 also determines whether to alert administrative personnel via administrative center 140 based on a result of an assessment. These and other features of monitoring subsystem 222 will be discussed in further detail below.

Database 230 consists of any number of databases and/or servers, and stores and organizes data in a relational database. Database 230 is configured to run a database management system, such as MYSQL′, to provide an example. Database 230 includes organized data such that respective identity data, authentication data, monitored data, profile data, jurisdictional requirements and rules, and settings that are indexed and associated with each of the inmates. Data stored in database 230 may be accessed by any of the processing subsystems.

### Prevention Subsystem

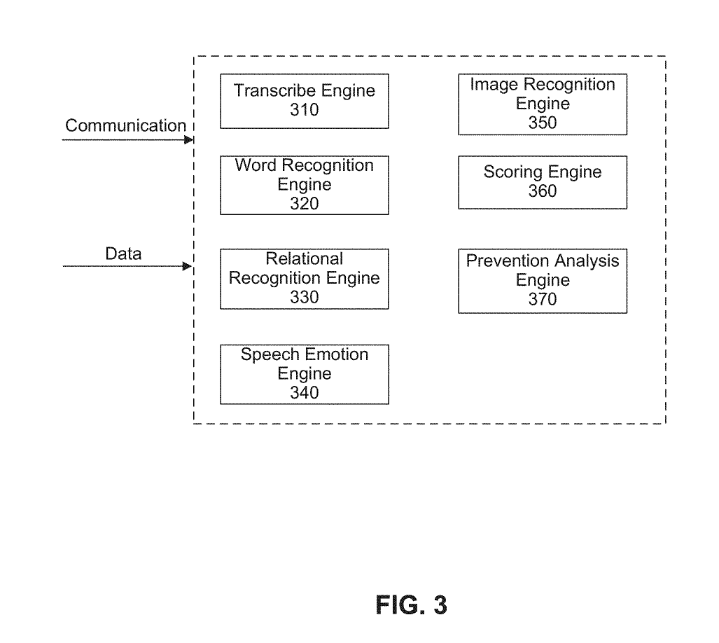

FIG. 3 illustrates a block diagram of prevention subsystem 300, according to embodiments of the present disclosure. Prevention subsystem 300 may be an exemplary embodiment of prevention subsystem 224. Prevention subsystem 300 includes a transcription engine 310, a word recognition engine 320, a relational recognition engine 330, a speech emotion engine 340, an image emotion engine 350, a scoring engine 360, and a prevention analysis engine 370.

Prevention subsystem 300 is configured to receive communications from communication subsystem 212 or database 230. Communications having audio, such as phone and video calls, are routed to a transcription engine 310 which transcribes audio and speech from the communication into text using speech recognition processing. In an embodiment, the audio portion of the communication may be transcoded to create a separate audio file of the communication. Transcription engine 310 is further configured to determine the individuals participating in the communication. Identifying the individuals may be done through a voice analysis, in combination with the authentication subsystem. 216. Along with the text, a transcript of a communication may clearly indicate which individuals are talking and a timestamp of each word and/or space between words. An output of the transcription engine 330 may be used by any of the other engines in performing analyses.

Word recognition engine 320 is configured to receive the transcript from the transcription engine 310 or to receive a non-audio communication itself. Word recognition engine 320 is also configured to analyze the communication and detect certain keywords. The detection of keywords consists of identifying within the text communication words or phrases from a keyword dictionary. In other words, keywords are generally identified in advance and stored in a keyword database 321 (i.e., dictionary). The keywords are those words or phrases that indicate a likelihood of an inmate to commit suicide. An output of the word recognition engine 330 may be used by any of the other engines in performing analyses.

Relational recognition engine 330 is configured to identify one or more relational indicators between words and phrases from an inmate's profile data or content of communication. Relational recognition engine 330 is configured to output data from any of the engines and audio communications, if available. Relational recognition engine then identifies one or more relational indicators between words and phrases used in the transcript, profile data, and/or audio communications. The relational indicators are words or phrases that when used in relationship to other words and phrases indicate a likelihood of an inmate to commit suicide. Relational recognition engine 330 identifies the relational indicators through analysis of such aspects as spacing between words or phrases, types of words and phrases used, particular terms used for the first time or increasingly being used by an inmate during communications, words or phrases used by an inmate in response to another individuals words or phrases, link charting, trend charting, or word association. Relational recognition engine 330 associates words or phrases with other words or phrases based on a relational database 331 which includes words, phrases, and rules to indicate a relationship. An output of the relational recognition engine 330 may be used by any of the other engines in performing analyses.

Speech emotion engine 340 is configured to determine an emotional state of an inmate through analysis of a speech portion of a communication. Speech emotion engine 340 is configured to receive communications and output data from any of the engines. An emotional state of an inmate may be determined through analysis of keywords, relational indicators, and voice analysis. The analysis may include an evaluation on the types of words or phrases used, changes in respiration for an inmate, or changes in acoustical characteristics of an inmate. The evaluations may compare a current communication in comparison with previous communications or prior data and/or standardized speech expressions or typical speech expressions for the inmate to determine if any changes have occurred in the inmate's speech. Speech emotion engine 340 includes, or accesses, a speech database 341 that includes the standardized speech expressions or typical speech expressions for the inmate.

Image emotion engine 350 is configured to determine an emotional state of an inmate through analysis of a video or image portion of a communication. Image emotion engine 340 is configured to receive communications and output data from any of the engines. Image emotion engine 350 is configured to analyze facial expressions of an inmate within the video or image portion of the communication by evaluating relational points on an inmate's face. Image emotion engine 350 can further compare the relational points to prior facial evaluations or standard facial evaluations, i.e. standardized facial expressions for an individual in different emotional states. Image emotion engine 350 includes, or accesses, an image database 351 that includes the standardized facial expressions or typical facial expressions for the inmate.

In an embodiment, prevention subsystem 300 also includes a scoring engine 360 configured to score outputs of the other engines. The scores are numerical values given to the output of the other engines for assessment in determining an inmate's suicidal risk. The scores may be normalized based on the output that is being scored. For example scores of keywords can be scored based on the specific word or phrase and scores for relational indicators may be weighted based on the relationship between the words and phrases. Examples of the scores include a score of 1-100 of each of the keywords, relational indicators, speech evaluators, and image evaluators, where those scores having a 1 have a low indication of the inmate's propensity to commit suicide and a score of 100 has a high indication of the inmate's suicidal risk.

Prevention analysis engine 370 is configured to perform statistical analysis on a wide variety of inmate data in order to generate a prevention score for different inmates. The prevention score is a representation of the inmate's likelihood of committing suicide.

In order to carry out ongoing scoring functionality, prevention analysis engine 370 uses the outputs from any or all of the different engines and all available data related to the inmate, such as profile data and inmate data, to calculate the prevention score. In an embodiment, prevention analysis engine 370 may be used to calculate an initial prevention score based initial inmate data received, such as profile data, and then updates the prevention score overtime based on communications involving the inmate.

Prevention analysis engine 370 is further configured to determine prevention actions that should be taken to support an inmate. In an embodiment, once prevention analysis engine 370 calculates the prevention score, the prevention score is weighed against different thresholds to determine an appropriate recommendation to help an inmate. The recommendation may include no recommended action, scheduling a visit with a therapist, recommending a phone call from a friend or family member, visits by those working at the correctional facility, keep under watch by a guard, use of suicide-resistant jail cells, use of safety smocks, or medicinal recommendations.

In an embodiment, prevention analysis engine 370 is configured to transmit an alert to administration center 140. The alert may include a recommendation for supporting an inmate. In an embodiment, the alert may also include one or more of a prevention score of the inmate, a reason(s) for a recommendation and/or prevention score for an inmate, or a change in a prevention score for an inmate. The alert may be viewed and/or received by a correctional facility worker, such as administrators, guards, medical assistants, or therapists, to provide support for an inmate. In an embodiment, prevention analysis engine 370 sends out the alert only if a prevention score for an inmate is above a predetermined threshold or a predetermined event has occurred to warrant an alert such as a significant change in the prevention score or a detection of an high emotion during a communication. Further, prevention analysis engine 370 is configured to perform some of the recommendations, such as scheduling a therapist or scheduling a real time communication between an inmate and a friend, without transmitting an alert.

### Operation of Communication System

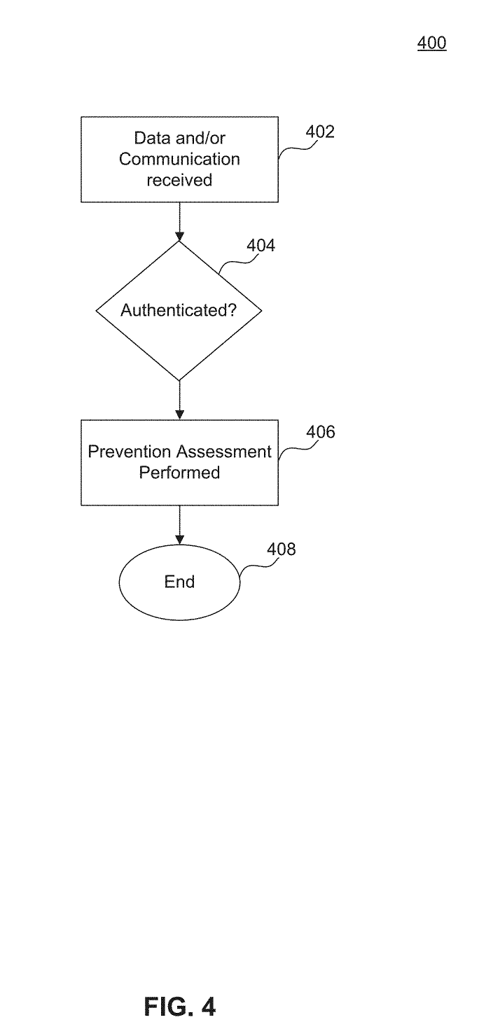

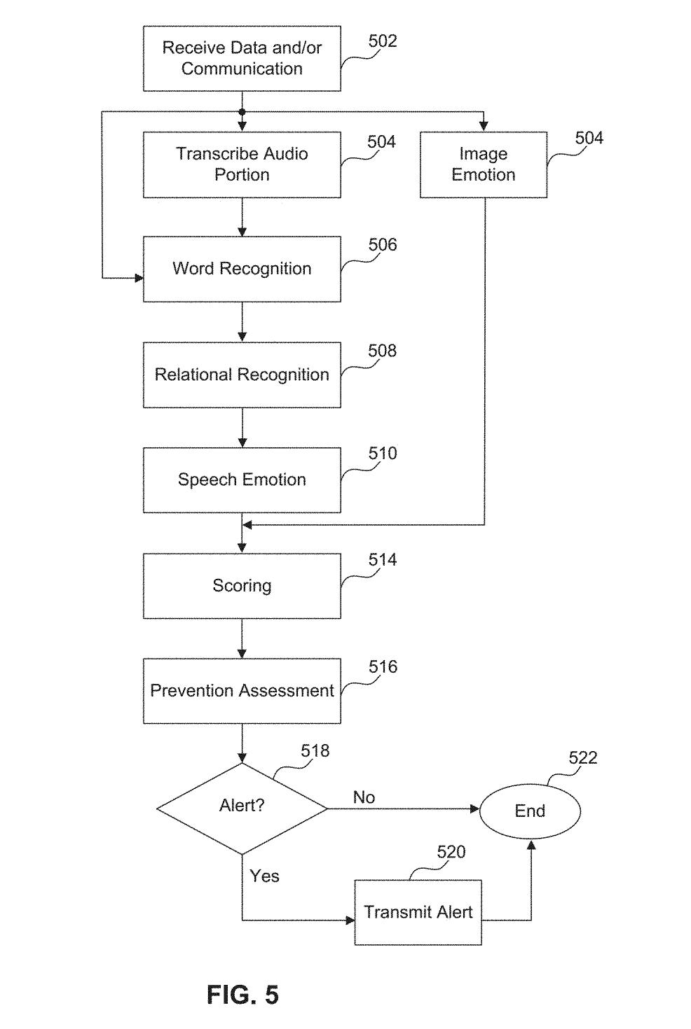

FIGS. 4-5 illustrates operations operation of communication system 100, according to exemplary embodiments of the present disclosure. Although the physical devices and components that form the system have largely already been described, additional details regarding their more nuanced operation will be described below with respect to FIGS. 1-3. The operations illustrated by FIGS. 4-5 are not limited to the order described below, and various operations can be performed in a different order or simultaneously with each other.

FIG. 4 illustrates an operation of communication system 100, according to embodiments of the present disclosure. In method 400, a communication or data related to an inmate is received by the communication system 100 (402). Examples of the communication may include any or all communications between inmate communication device 120 and outsider communication device 130, from monitoring device 128, or between an inmate and application on the inmate communication device 120 (e.g., a chatbot). Examples of data may include initial registration information or profile data received when an inmate registers to use the communication system 100.

Once received, the communication and/or the data is authenticated by the authentication subsystem 216 (404). In the case of registration, profile subsystem 214 receives information regarding an inmate such as name, biometrics, history and retrieves additional information from such databases as a JMS database, an OMS database, or a public database. All information is verified against other information and may be verified by an administrator. In the case of a communication, the authentication subsystem 216 performs an identity verification by comparing a sampling of data received from a purported inmate with the identity data stored in database 230. The sampling of data may include a username and a password, a biometric sample of the purported inmate such as an audio sample, a fingerprint, a facial sample (2D or 3D), a retinal sample, or a device identification such as make and model of a communication device 120 used by the purported inmate.

If authentication and verification checks fail, the registration process ends or the communication ends (410). Otherwise, data and/or the communication is made available to prevention subsystem 224 to perform a suicide prevention assessment (406), which is explained in more detail below. Once a prevention assessment is completed, the operation of communication system 100 ends (410).

FIG. 5 illustrates a flowchart diagram of an operation of prevention subsystem 224, according to exemplary embodiments of the present disclosure. Once data or a communication has been authenticated, the operation of prevention subsystem 224 begins. Prevention subsystem 224 performs suicide prevention assessment using text communications, voice communications, video communications, and other data related to an inmate. In the example of method 500, a method of performing a suicide prevention assessment for a video communication will be discussed. However, as will be recognized by those skilled in the art, in other embodiments, data or other types of communications may be assessed used similar operations.

In method 500, a video communication is received by the prevention subsystem 224 (502). The video communication may include a video communication, including audio and video portions, between inmate communication device 120 and outsider communication device 130, a video communication from monitoring device 128, or a video communication between an inmate and application on the inmate communication device 120 (e.g., a chatbot). Further, the video communication may be either a real time communication or one that was received from the database 230.

Next, the received video communication is transcribed (504). Using the transcript of the communication, word recognition is then performed (506). During this operation, word recognition engine 320 detects keywords that indicate a likelihood of an inmate to commit suicide in the manner describe above.

After, a relational analysis is performed on the transcribed communication by relational recognition engine 330 to identify relational indicators (508), as described above. Next, an emotional state of an inmate is then determined by speech emotion engine 340 through analysis of a speech portion of the communication (510). Further, a video portion of the communication may be evaluated by image emotion engine 350 to determine an emotional state of the inmate based on facial expressions of the inmate (512).

In an embodiment, scoring engine 360 receives results from any and all engines and determines scores for each of the results (514), as previously described. After, prevention assessment is performed by prevention analysis engine 370 (516). The prevention assessment determines an overall prevention score that is used to evaluate the inmate's likelihood of committing suicide. Prevention analysis engine 370 analyzes any and all data and results from other engines to obtain the prevention score.

Next, prevention analysis engine 370 compares the prevention score to at least one threshold to determine whether an alert is necessitated by the level of suicidal risk for the inmate (518). If no alert is needed, the prevention assessment ends (522). Otherwise, an alert is transmitted to the administration center 140 (520) to indicate that support is needed for the inmate. After the alert is transmitted, the prevention assessment ends (522).

### Exemplary Computer Implementation

It will be apparent to persons skilled in the relevant art(s) that various elements and features of the present disclosure, as described herein, can be implemented in hardware using analog and/or digital circuits, in software, through the execution of computer instructions by one or more processors, or as a combination of hardware and software.

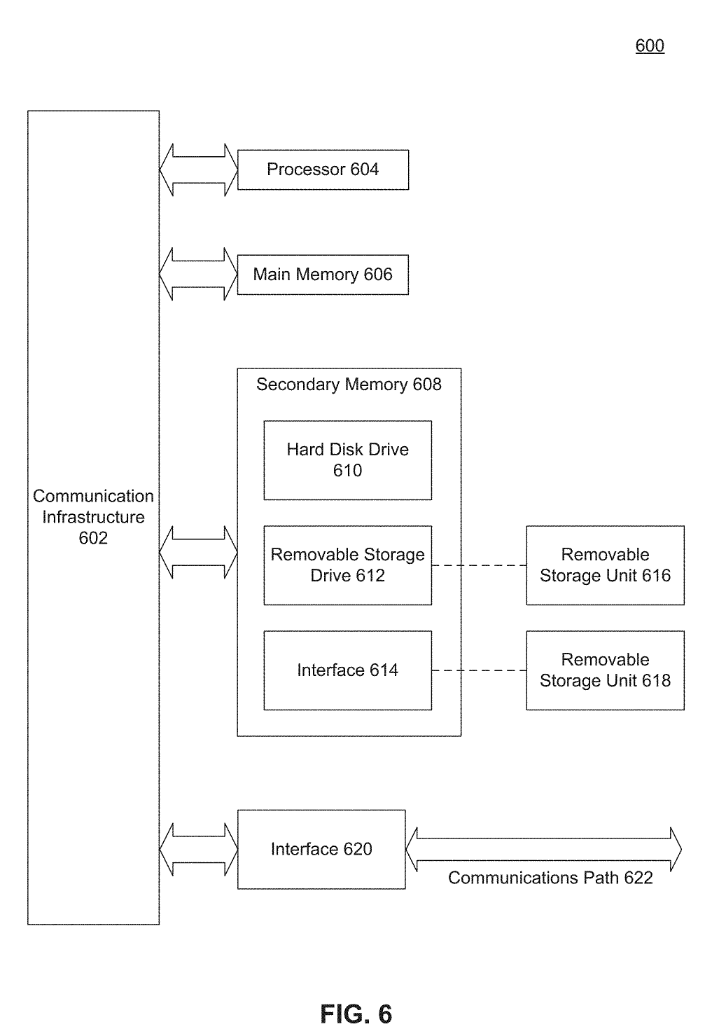

The following description of a computer system is provided for the sake of completeness. Embodiments of the present disclosure can be implemented in hardware, or as a combination of software and hardware. Consequently, embodiments of the disclosure may be implemented in the environment of a computer system or other processing system. An example of such a computer system 600 is shown in FIG. 6.

Computer system 600 includes one or more processors, such as processor 604. Processor 604 can be a special purpose or a general purpose digital signal processor. Processor 604 is connected to a communication infrastructure 602 (for example, a bus or network). Various software implementations are described in terms of this exemplary computer system. After reading this description, it will become apparent to a person skilled in the relevant art(s) how to implement the disclosure using other computer systems and/or computer architectures.

Computer system 600 also includes a main memory 606, preferably random access memory (RAM), and may also include a secondary memory 608. Secondary memory 608 may include, for example, a hard disk drive 610 and/or a removable storage drive 612, representing a floppy disk drive, a magnetic tape drive, an optical disk drive, or the like. Removable storage drive 612 reads from and/or writes to a removable storage unit 616 in a well-known manner. Removable storage unit 616 represents a floppy disk, magnetic tape, optical disk, or the like, which is read by and written to by removable storage drive 612. As will be appreciated by persons skilled in the relevant art(s), removable storage unit 616 includes a computer usable storage medium having stored therein computer software and/or data.

In alternative implementations, secondary memory 608 may include other similar means for allowing computer programs or other instructions to be loaded into computer system 600. Such means may include, for example, a removable storage unit 618 and an interface 614. Examples of such means may include a program cartridge and cartridge interface (such as that found in video game devices), a removable memory chip (such as an EPROM, or PROM) and associated socket, a thumb drive and USB port, and other removable storage units 618 and interfaces 614 which allow software and data to be transferred from removable storage unit 618 to computer system 600.

Computer system 600 may also include a communications interface 620. Communications interface 620 allows software and data to be transferred between computer system 600 and external devices. Examples of communications interface 620 may include a modem, a network interface (such as an Ethernet card), a communications port, a PCMCIA slot and card, etc. Software and data transferred via communications interface 620 are in the form of signals which may be electronic, electromagnetic, optical, or other signals capable of being received by communications interface 620. These signals are provided to communications interface 620 via a communications path 622. Communications path 622 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 616 and 618 or a hard disk installed in hard disk drive 610. These computer program products are means for providing software to computer system 600.

Computer programs (also called computer control logic) are stored in main memory 606 and/or secondary memory 608. Computer programs may also be received via communications interface 620. Such computer programs, when executed, enable the computer system 600 to implement the present disclosure as discussed herein. In particular, the computer programs, when executed, enable processor 604 to implement the processes of the present disclosure, such as any of the methods described herein. Accordingly, such computer programs represent controllers of the computer system 600. Where the disclosure is implemented using software, the software may be stored in a computer program product and loaded into computer system 600 using removable storage drive 612, interface 614, or communications interface 620.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### CONCLUSION

It is to be appreciated that the Detailed Description section, and not the Abstract section, is intended to be used to interpret the claims. The Abstract section may set forth one or more, but not all exemplary embodiments, and thus, is not intended to limit the disclosure and the appended claims in any way.

The disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made therein without departing from the spirit and scope of the disclosure. Thus, the disclosure should not be limited by any of the above-described exemplary embodiments, but should be defined only in accordance with the following claims and their equivalents.

What is claimed is:

1. A system for providing suicide prevention and support for an inmate in a correctional facility, the system comprising:
an inmate communication device configured to generate a communication; and
one or more processors configured to:
receive the communication from the inmate communication device;
perform a prevention analysis on the communication to determine a suicidal risk of the inmate;
calculate a prevention score indicating the likelihood of the inmate to commit suicide based on a result of the prevention analysis; and
generate an alert based on the prevention score.

2. The system of claim 1, wherein the communication comprises one or more of a text, an email, an audio communication, or a video communication.

3. The system of claim 1, wherein the one or more processors is further configured to determine prevention actions to support the inmate based on the prevention score.

4. The system of claim 3, wherein the alert comprises the prevention score and the prevention actions.

5. The system of claim 1, wherein the one or more processors is further configured to analyze the communication and detect keywords, and to calculate the prevention scored based on the keywords.

6. The system of claim 1, wherein the one or more processors is further configured to identify one or more relational indicators between words and phrases in the communication, and to calculate the prevention scored based on the one or more relational indicators.

7. The system of claim 1, wherein the one or more processors is further configured to determine an emotional state of an inmate through analysis of a speech portion of the communication, and to calculate the prevention scored based on a result of the analysis of the speech portion.

8. The system of claim 1, wherein the one or more processors is further configured to determine an emotional state of the inmate through analysis of a video or image portion of the communication, and to calculate the prevention scored based on a result of the analysis of the speech portion.

9. The system of claim 1, further comprising a monitoring device located within the correctional facility and configured to:
monitor actions or sounds from the inmate;
generate monitored data based on the monitored actions or sound; and
transmit the monitored data to the one or more processors,
wherein the one or more processors is further configured to calculate the prevention scored based on the monitored data.

10. The system of claim 1, further comprising an administration station configured to receive the alert and to distribute the alert to a worker of the correctional facility.

11. A system for providing suicide prevention and support for an inmate in a correctional facility, the system comprising:
an inmate communication device configured to generate a communication; and
one or more processors configured to:
receive the communication from the inmate communication device;
perform a prevention analysis to determine a suicidal risk of the inmate, the prevention analysis comprising an analysis of the communication and profile data associated with the inmate;
calculate a prevention score indicating the likelihood of the inmate to commit suicide based on a result of the prevention analysis; and
generate an alert based on the prevention score.

12. The system of claim 1, wherein the profile data comprises one or more of a medical history, a communication history, a family medical history, booking information, or a criminal history of the inmate.

13. The system of claim 1, wherein the one or more processors is further configured to determine a prevention action to support the inmate based on the prevention score.

14. The system of claim 13, wherein the one or more processors is further configured to initiate the prevention action when the prevention score indicates that the inmate is at a low risk for suicide.

15. The system of claim 11, wherein the one or more processors is further configured to generate the alert to include the prevention score and recommendations for supporting the inmate.

16. The system of claim 11, wherein the one or more processors is further configured to generate a transcription by transcribing an audio portion of the communication and to analyze the communication based on the transcription.

17. The system of claim 11, wherein the one or more processors is further configured to identify one or more relational indicators between words and phrases in the communication and the profile data, and to calculate the prevention scored based on the one or more relational indicators.

18. A system for providing suicide prevention and support for an inmate in a correctional facility, the system comprising:
an inmate communication device configured to generate a communication;
a monitoring device located within the correctional facility and configured to:
monitor actions or sounds from the inmate; and
generate monitored data based on the monitored actions or sound; and
one or more processors configured to:
receive the communication from the inmate communication device;
receive the monitored data from the monitoring device;
perform a prevention analysis to determine a suicidal risk of the inmate, the prevention analysis comprising an analysis of the communication and the monitored data associated with the inmate;
calculate a prevention score indicating the likelihood of the inmate to commit suicide based on a result of the prevention analysis; and
generate an alert based on the prevention score.

19. The system of claim 18, further comprising an administration station configured to receive the alert and to distribute the alert to a worker of the correctional facility.

20. The system of claim 18, wherein the one or more processors is further configured to identify one or more relational indicators between words and phrases in the communication and the monitored data, and to calculate the prevention scored based on the one or more relational indicators.
